(19) United States
(12) Patent Application Publication
(10) Pub. No.: US 2010/0283918 A1
(43) Pub. Date: Nov. 11, 2010

(54) APPARATUS AND METHOD FOR ESTIMATING CARRIER FREQUENCY ERROR

(76) Inventor: Benyuan Zhang, Cherry Hill, NJ (US)

Correspondence Address: Robert D. Shedd, Patent Operations;THOMSON Licensing LLC, P.O. Box 5312, Princeton, NJ, 08543-5312, US

(21) Appl. No.: 12/735,250

(22) PCT Filed: Dec. 27, 2007
(86) PCT No.: PCT/US2007/026377

§ 371 Date: Jun. 25, 2010

(51) Int. Cl. H04L 27/00; H04N 5/44

(52) U.S. Cl. 348/735; 375/344; 348/E05.096

(57) ABSTRACT

A receiver is an ATSC receiver having at least two modes of operation. In a first mode of operation the ATSC receiver determines an initial carrier frequency offset with respect to a carrier frequency in the received signal as a function of a field sync signal in the received signal. In a second mode of operation, the ATSC receiver tracks a carrier frequency in a received signal using a carrier tracking loop.

### BACKGROUND OF THE INVENTION

The present invention generally relates to communications systems and, more particularly, to a receiver.

In the ATSC (Advanced Television Systems Committee) standard for digital terrestrial television (DTV) in the United States (e.g., see, United States Advanced Television Systems Committee, “ATSC Digital Television Standard”, Document A/53, Sep. 16, 1995), the modulation system consists of a suppressed carrier vestigial sideband (VSB) modulation with an added small in-phase pilot at the suppressed carrier frequency, 11.3 dB below the average signal power. An illustrative spectrum for an ATSC VSB signal is shown in FIG. 1.

The format of ATSC VSB signal, or ATSC signal, is shown in FIGS. 2 and 3. DTV data is modulated using 8-VSB (vestigial sideband) and transmitted in data segments. An ATSC data segment is shown in FIG. 2. The ATSC data segment consists of 832 symbols: four symbols for data segment synchronization (sync), and 828 data symbols. As can be observed from FIG. 2, the data segment sync is inserted at the beginning of each data segment and is a two-level (binary) four-symbol sequence representing the binary 1001 pattern, which corresponds to [5-5-5 5] in terms of 8-VSB symbol. Multiple data segments (313 segments) comprise an ATSC data field, which comprises a total of 260,416 symbols (832×313). The first data segment in a data field is called the field sync segment. The structure of the field sync segment is shown in FIG. 3, where each symbol represents one bit of data (two-level). In the field sync segment, a pseudo-random sequence of 511 bits (PN511) immediately follows the data segment sync. After the PN511 sequence, there are three identical pseudo-random sequences of 63 bits (PN63) concatenated together, with the second PN63 sequence being inverted every other data field.

A typical ATSC-VSB receiver includes a carrier tracking loop (CTL) that processes a received ATSC VSB signal to both remove any frequency offsets between the local oscillator (LO) of the transmitter and LO of the receiver and to demodulate the received ATSC VSB signal down to baseband from an intermediate frequency (IF) or near baseband frequency (e.g., see, United States Advanced Television Systems Committee, “Guide to the Use of the ATSC Digital Television Standard”, Document A/54, Oct. 4, 1995; and U.S. Pat. No. 6,233,295 issued May 15, 2001 to Wang, entitled “Segment Sync Recovery Network for an HDTV Receiver”). The CTL generally includes: a Hilbert filter and corresponding delay, a complex multiplier, a phase detector, a first order loop filter, with a proportional plus integrator path, a numeric controlled oscillator (NCO) and a sine-cosine lookup table. Generally, the ATSC receiver must detect whether the CTL is “locked” or “unlocked” to the received ATSC VSB signal. For example, if the ATSC receiver detects that the CTL is locked, then the ATSC receiver determines that the received ATSC VSB signal is “good” and can be used for subsequent recovery of the data conveyed therein. However, if the ATSC receiver detects that the CTL is unlocked, then the ATSC receiver determines that the received ATSC signal is “bad” such that portions of the ATSC receiver may then be reset to, e.g., flush out any recovered data now associated with the bad received ATSC VSB signal, i.e., erroneous data. In addition, after the ATSC receiver detects that the CTL is locked, the CTL loop filter parameter may be changed to decrease the loop bandwidth and reject thermal noise.

Unfortunately, at the ATSC-receiver power up, the initial carrier frequency error in the ATSC system could be as large as 100 kHz to 200 kHz. Such a large initial carrier frequency error degrades system performance and extends power-up system convergence time. This can result in additional time delay before a user can watch a television (TV) program.

### SUMMARY OF THE INVENTION

In accordance with the principles of the invention, a receiver receives a signal having a carrier frequency and determines an initial frequency offset with respect to the carrier frequency in the received signal as a function of a synchronization signal in the received signal.

In an illustrative embodiment of the invention, the receiver is an ATSC receiver having at least two modes of operation. In a first mode of operation the ATSC receiver determines an initial carrier frequency offset with respect to a carrier frequency in the received signal as a function of a field sync signal in the received signal. In a second mode of operation, the ATSC receiver tracks a carrier frequency in a received signal using a carrier tracking loop.

In view of the above, and as will be apparent from reading the detailed description, other embodiments and features are also possible and fall within the principles of the invention.

### BRIEF DESCRIPTION OF THE DRAWINGS

FIG. 1 shows an illustrative ATSC VSB signal spectrum;

FIGS. 2 and 3 show a format for an ATSC DTV signal;

FIG. 4 shows an illustrative high-level block diagram of an apparatus embodying the principles of the invention;

FIG. 5 shows a portion of a receiver embodying the principles of the invention;

FIG. 6 shows Table One, illustrating different operating modes in accordance with the principles of the invention;

FIG. 7 shows an illustrative flow chart in accordance with the principles of the invention;

FIG. 8 shows another illustrative flow chart in accordance with the principles of the invention;

FIG. 9 shows an illustrative embodiment of element 125 of FIG. 5;

FIG. 10 shows an illustrative embodiment of element 225 of FIG. 9;

FIG. 11 shows an illustrative embodiment of element 255 of FIG. 10;

FIG. 12 shows an illustrative flow chart for use in element 225 of FIG. 9; and

FIG. 13 shows an illustrative flow chart for use in element 230 of FIG. 9.

### DETAILED DESCRIPTION

Other than the inventive concept, the elements shown in the figures are well known and will not be described in detail. Also, familiarity with television broadcasting, receivers and video encoding is assumed and is not described in detail herein. For example, other than the inventive concept, familiarity with current and proposed recommendations for TV standards such as NTSC (National Television Systems Committee), PAL (Phase Alternation Lines), SECAM (SEquential Couleur Avec Memoire) and ATSC (Advanced Television Systems Committee) (ATSC) is assumed. Further information on ATSC broadcast signals can be found in the following ATSC standards: Digital Television Standard (A/53), Revision C, including Amendment No. 1 and Corrigendum No. 1, Doc. A/53C; and Recommended Practice: Guide to the Use of the ATSC Digital Television Standard (A/54). Likewise, other than the inventive concept, transmission concepts such as eight-level vestigial sideband (8-VSB), Quadrature Amplitude Modulation (QAM), orthogonal frequency division multiplexing (OFDM) or coded OFDM (COFDM)), and receiver components such as a radio-frequency (RF) front-end, receiver section, low noise block, tuners, demodulators, Hilbert filters, carrier tracking loop, correlators, leak integrators and squarers is assumed. Similarly, other than the inventive concept, formatting and encoding methods (such as Moving Picture Expert Group (MPEG)-2 Systems Standard (ISO/IEC 13818-1)) for generating transport bit streams are well-known and not described herein. Also, those skilled in the art appreciate that carrier recovery involves processing in the real and the complex domains. It should also be noted that the inventive concept may be implemented using conventional programming techniques, which, as such, will not be described herein. Finally, like-numbers on the figures represent similar elements.

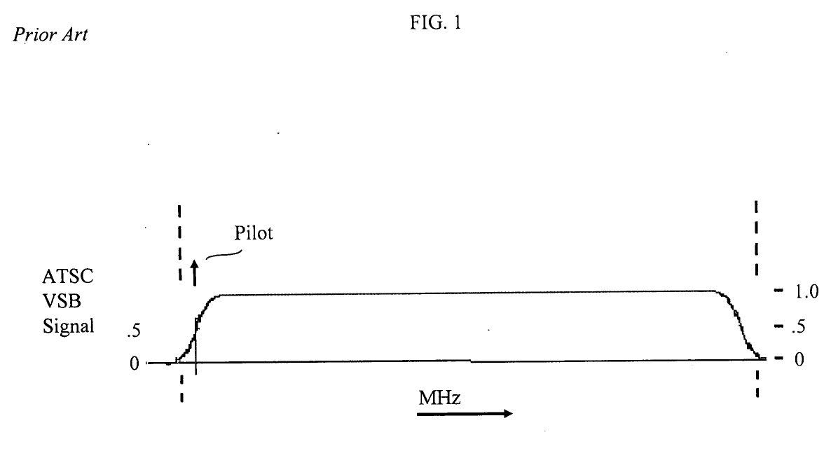

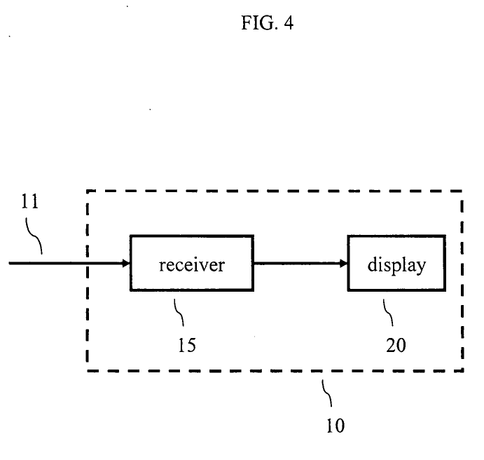

A high-level block diagram of an illustrative apparatus 10 in accordance with the principles of the invention is shown in FIG. 4. Apparatus 10 includes a receiver 15 and a display 20. Illustratively, receiver 15 is an ATSC-compatible receiver. It should be noted that receiver 15 may also be NTSC (National Television Systems Committee)-compatible, i.e., have an NTSC mode of operation and an ATSC mode of operation such that apparatus 10 is capable of displaying video content from an NTSC broadcast or an ATSC broadcast. For simplicity in describing the inventive concept, only the ATSC mode of operation is described herein. Receiver 15 receives a broadcast signal 11 (e.g., via an antenna (not shown)) for processing to recover therefrom, e.g., an HDTV (high definition TV) video signal for application to display 20 for viewing video content thereon. As noted earlier, an illustrative spectrum for an ATSC VSB signal is shown in FIG. 1.

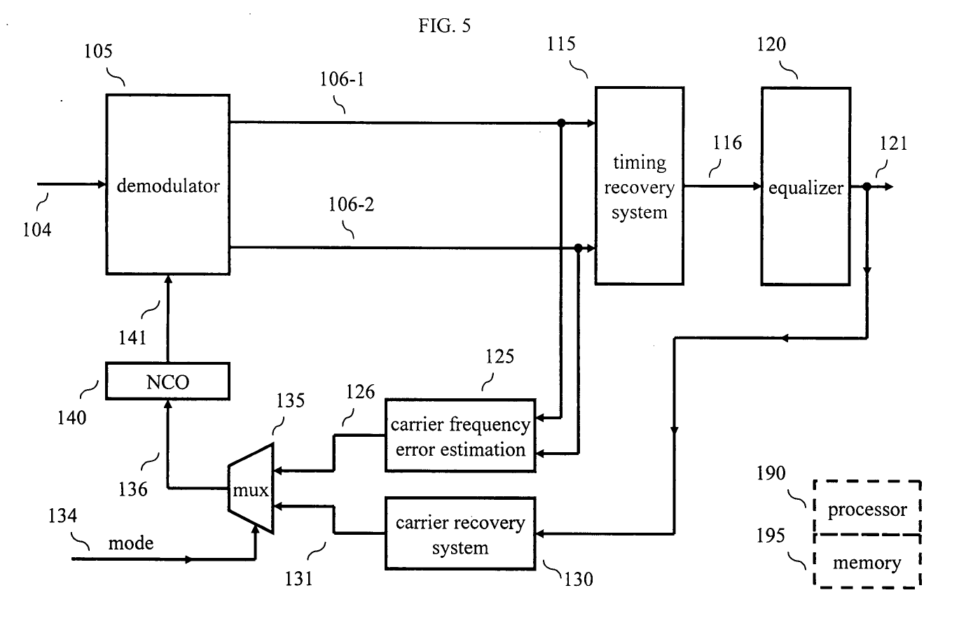

Turning now to FIG. 5, that relevant portion of receiver 15 in accordance with the principles of the invention is shown. In particular, receiver 15 includes demodulator 105, timing recovery system 115, equalizer 120, carrier frequency error estimation element 125, carrier recovery system 130, multiplexer (mux) 135 and numerically controlled oscillator (NCO) 140. Other than the inventive concept, the elements shown in FIG. 5 are well-known and not described herein. Receiver 15 is a processor-based system and includes one, or more, processors and associated memory as represented by processor 190 and memory 195 shown in the form of dashed boxes in FIG. 5. In this context, computer programs, or software, are stored in memory 195 for execution by processor 190 and, e.g., implement the equalizer 120. Processor 190 is representative of one, or more, stored-program control processors and these do not have to be dedicated to the receiver function, e.g., processor 190 may also control other functions of receiver 15 (or apparatus 10). Memory 195 is representative of any storage device, e.g., random-access memory (RAM), read-only memory (ROM), etc.; may be internal and/or external to receiver 15; and is volatile and/or non-volatile as necessary.

Receiver 15 further comprises a front-end block (not shown, e.g., comprising a tuner, etc.) for receiving broadcast signal 11 (conveying content for a selected channel) and providing a near baseband received signal 104 to demodulator 105. The latter performs demodulation of received signal 104 and provides a complex demodulated signal 106 represented by an in-phase signal component 106-1 and a quadrature signal component 106-2 to timing recovery system 115. Timing recovery system 115 performs symbol timing recovery and provides signal 116 to equalizer 120, which equalizes the signal and provides equalized signal 121. The latter is provided to other portions (not shown) of receiver 15 for recovery of the data conveyed therein and is also provided to carrier recovery system 130 for use in tracking the carrier frequency of the received signal. In this regard, and in accordance with the principles of the invention, receiver 15 operates in at least two modes of operation. A carrier recovery mode and a carrier frequency error estimation mode. The selected mode of operation is controlled via mode signal 134, which is provided, e.g., by processor 195.

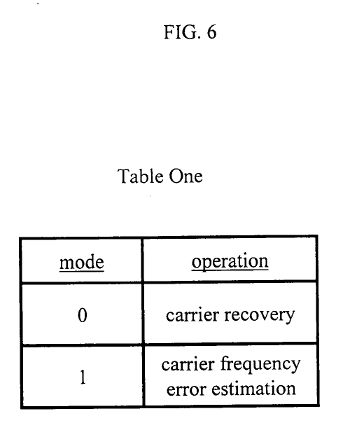

Turning briefly to FIG. 6, Table One illustrates the at least two modes of operation for different logic levels of mode signal 134. For example, when mode signal 134 is “LOW” —associated with a logic level of “0”, the carrier recovery mode is selected. Returning to FIG. 5, mode signal 134 controls mux 135, which provides a different signal in accordance with the selected mode to NCO 140, via signal 136. In the carrier recovery mode, mux 135 provides output signal 131 from carrier recovery system 130; while in the carrier frequency error estimation mode, mux 135 provides output signal 126 from carrier frequency error estimation element 125.

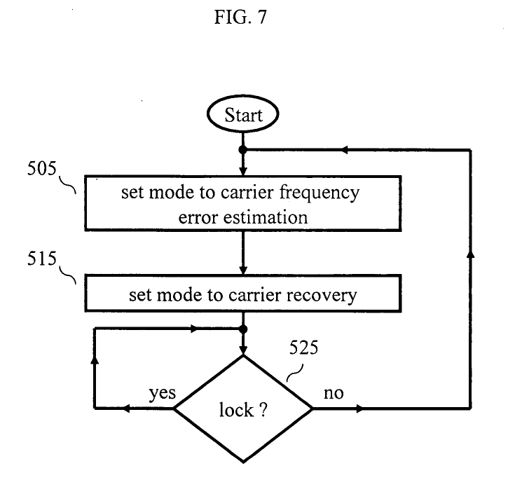

Turning now to FIG. 7, an illustrative flow chart for use in receiver 15 in accordance with the principles of the invention is shown. For example, at the start of receiver operation, or upon a reset, receiver 15 sets the mode to the carrier frequency error estimation mode in step 505. In the carrier frequency error estimation mode, carrier frequency error estimation element 125 is responsive to demodulated signal 106 (as represented by in-phase signal component 106-1 and quadrature signal component 106-2) for quickly estimating the frequency error and controlling NCO 140 to provide estimated carrier signal 141 to demodulator 105 for use in demodulating received signal 104. Thus, and in accordance with the principles of the invention, the carrier frequency error estimation mode enables the receiver to quickly estimate the initial frequency error with a resulting improvement in carrier recovery, timing recovery and equalization performance. After estimating the frequency error offset for use by NCO 140, receiver 15 switches to the carrier recovery mode of operation in step 515. In the carrier recovery mode of operation, carrier recovery system 130 is responsive to equalized signal 121 for tracking a carrier of the received signal and controls NCO 140 to provide estimated carrier signal 141 to demodulator 105 for use in demodulating received signal 104. It should be noted that, other than the inventive concept, in this mode of operation, the elements (105, 115, 120, 130 and 140) shown in FIG. 5 perform carrier tracking as known in the art, e.g., a carrier tracking loop. In step 525, receiver monitors if the carrier recovery system loses “lock”. Once lock is lost, receiver 15 returns to step 505 and begins the process again.

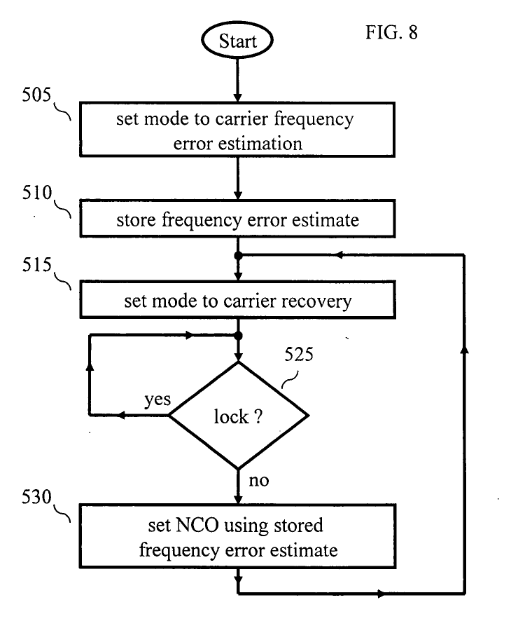

It should be noted that the flow chart of FIG. 7 can be further modified in accordance with the principles of the invention. For example, FIG. 8 shows an alternative flow chart, which now adds step 510 for storing the frequency error estimate determined in step 505. In this regard, when lock is lost in step 525, instead of determining anew the frequency error estimate, the stored frequency error estimate is used for the NCO in step 530. It should be noted that the drawing of FIG. 5 would be suitably modified, e.g., by providing an additional mode, and input, for mux 135 for providing the stored frequency error estimate to NCO 140. For example, mux 135 can select between four input signals, only three of which are used, signal 131, signal 126 and a signal for providing the stored frequency error estimate. In this regard, mode signal 134 would have four states, or modes, only three of which are used for selecting the appropriate input signal to provide as output signal 136 to NCO 140.

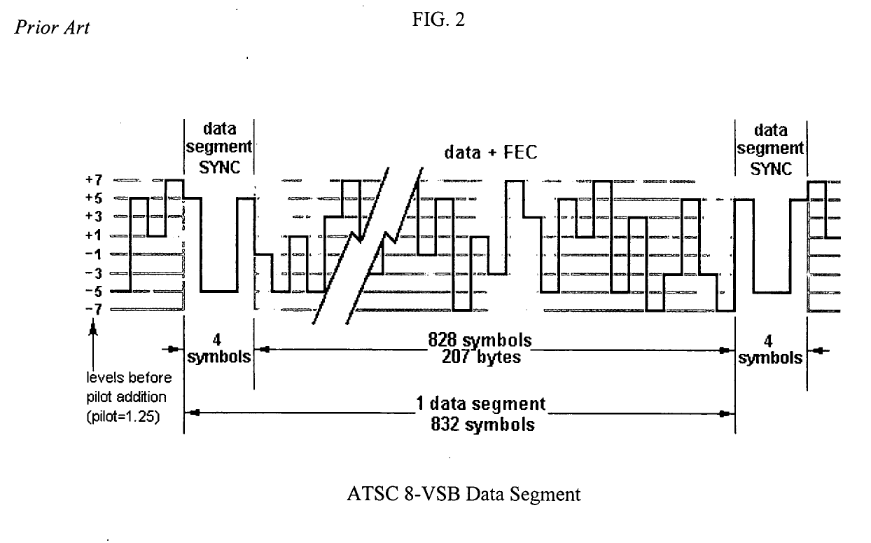

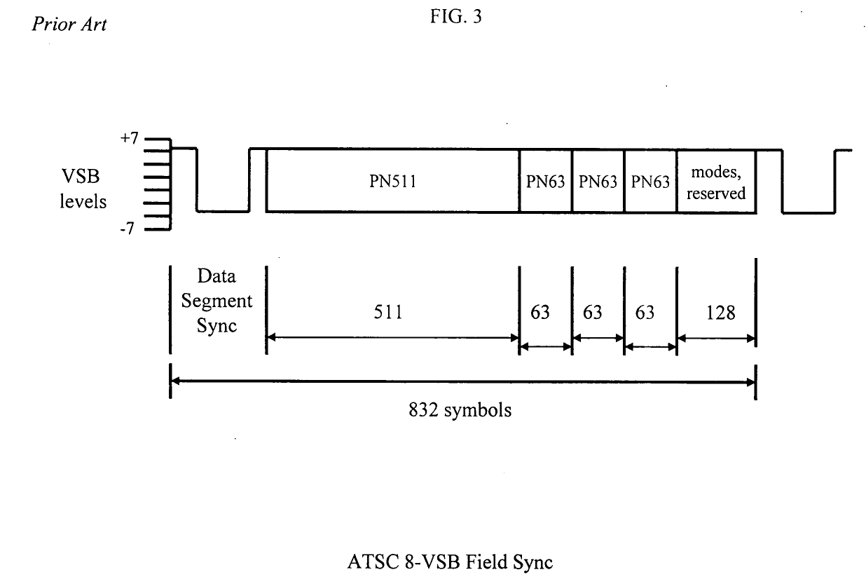

In an illustrative embodiment of the invention, carrier frequency error estimation element 125 uses the ATSC field sync segment for estimating the initial frequency error. In the ATSC frame structure, as illustrated in FIGS. 2 and 3, a data field occurs every 24.2 milliseconds (ms). The first data segment in the data field is called the field sync segment. The structure of the field sync segment is shown in FIG. 3, where each symbol represents one bit of data (two-level). In the field sync segment, a pseudo-random sequence of 511 bits (PN511) immediately follows the data segment sync. After the PN511 sequence, there are three identical pseudo-random sequences of 63 bits (PN63) concatenated together, with the second PN63 sequence being inverted every other data field. In other words, the field sync segments are distinguished in even and odd data fields with a flipping of the symbol sign for a 63 symbol duration. The major purpose of the field sync segment is for transport frame synchronization. Unfortunately, when frequency errors exist it is very difficult to separate an even data field from an odd data field. However, and in accordance with the principles of the invention, despite the fact that a frequency error may make it even impossible to distinguish between an even data field or an odd data field, the field sync segments have a long common continuous sequence at the beginning: a 4 segment sync symbol, 511 first part PN sequence and a 63 second part PN sequence for a total if 578 symbols as shown in FIG. 3.

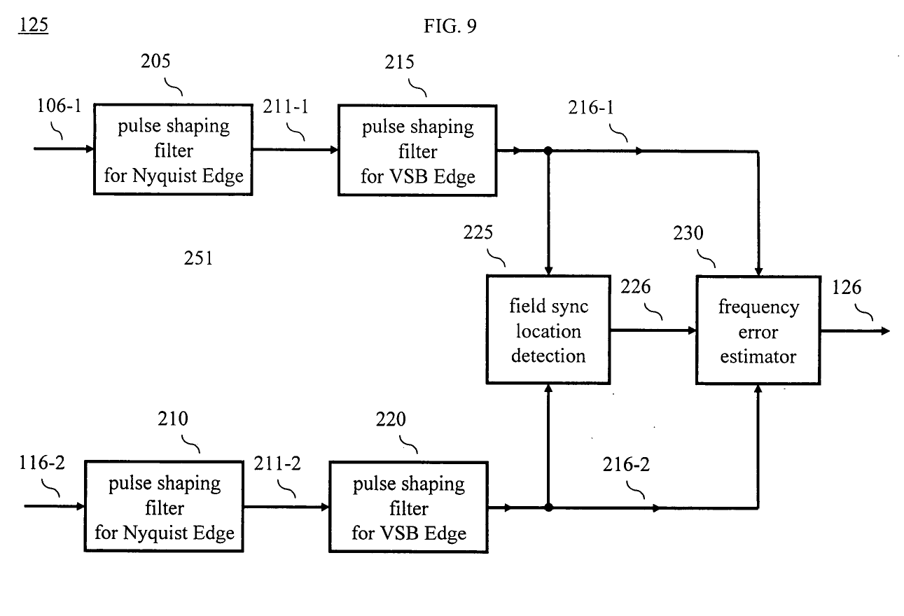

Turning now to FIG. 9, an illustrative embodiment of carrier frequency error estimation element 125 is shown. Carrier frequency error estimation element 125 comprises four filters: 205, 210, 215 and 220, a field sync location detection element 225 and a frequency error estimator element 230. As can be observed from FIG. 9, the in-phase signal component 106-1 and the quadrature signal component 106-2 are applied to filters 205 and 210, respectively. Of the four filters, two filters —205 and 210 —perform pulse shaping for removing the top edge. The other two filters —215 and 220 —perform pulse shaping for removing the bottom edge. Alternatively, two passband filters can be used, one passband filter replacing filters 205 and 215 for the in-phase signal component, and the other passband filter replacing filters 210 and 220 for the quadrature signal component. After filtering, field sync location detection element 225 determines the field sync timing by detecting the location of the field sync in filtered signals 216-1 and 216-2 using the above-noted 578 symbol sequence of the field sync (also shown in FIG. 3). Based on the determined field sync timing (signal 226) and the field sync signal conveyed via signals 216-1 and 216-2, frequency error estimate element 230 estimates the frequency error for use as an initial frequency offset, which is provided to NCO 140, via signal 126.

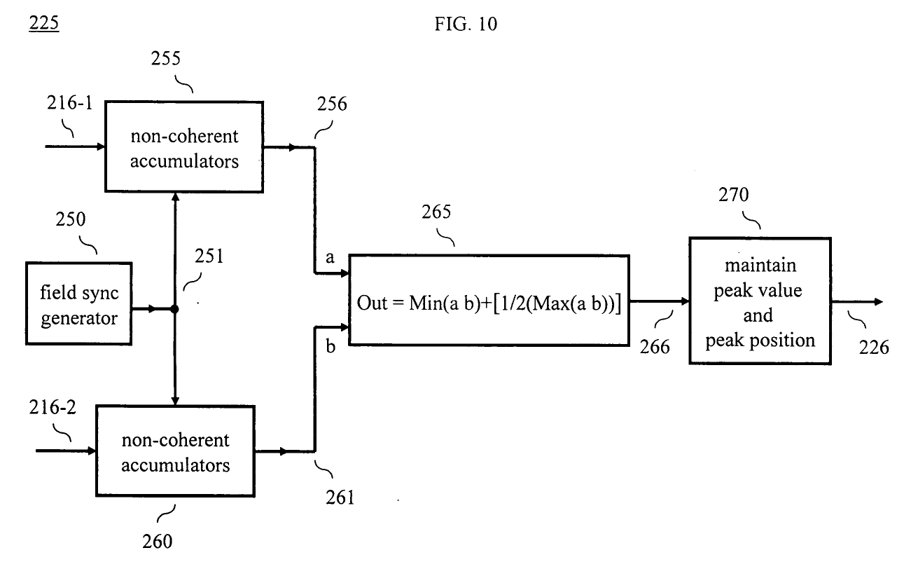

Referring now to FIG. 10, an illustrative embodiment of field sync location detection element 225 is shown. Field sync location detection element 225 comprises field sync generator 250, non-coherent accumulators 255 and 206, element 265 and element 270. Field sync generator 250 generates the above-noted 578 code sequence (e.g., as shown in FIG. 3). Both non-coherent accumulators 255 and 206 search for, or match, this 578 code sequence in the received signal as represented by in-phase component 216-1 and quadrature component 216-2. Non-coherent accumulator 255 provides output signal 256 (also denoted as signal “a” in FIG. 10). Non-coherent accumulator 260 provides output signal 261 (also denoted as signal “b” in FIG. 10). Element 265 implements the following equation (also shown in FIG. 10) with respect to inputs signals “a” and “b” for providing output signal 266 (Out):

Out=Min(a b)+[½(Max(a b))]. (1)

Element 270 determines the peak value of output signal 266 and also the peak position to provide an output signal 226 for enabling frequency error estimator 126. It should be noted that non-coherent accumulators 255 and 260 are equivalent to matched filters matched to the above-noted 578 code sequence.

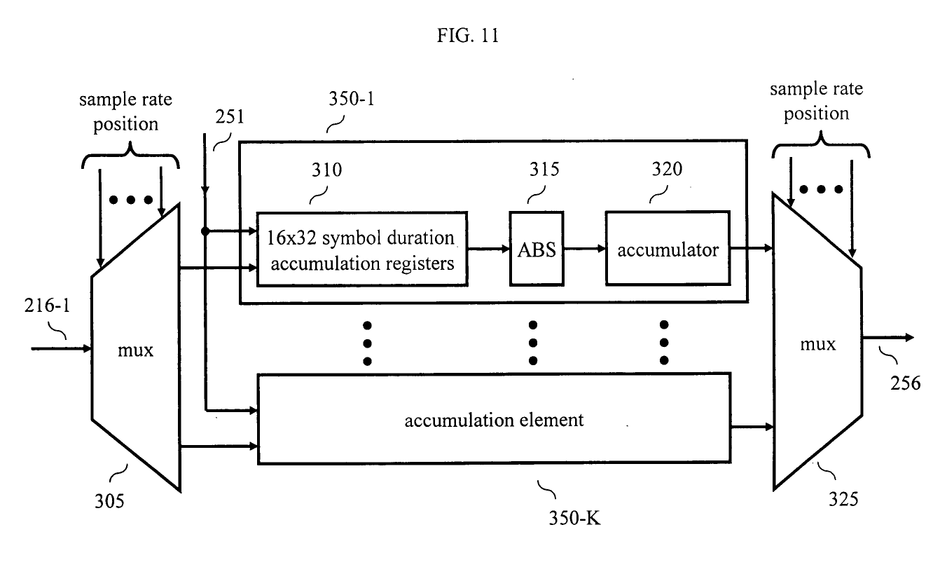

FIG. 11 shows an example of non-coherent accumulators 255. Non-coherent accumulators 260 is similar and not described herein. Non-coherent accumulators 255 comprises multiplexer (mux) 305, mux 325, and K banks of accumulation elements 350-1 to 350-K. Illustratively, K has a value of the sample rate of the symbol (the higher the sample rate, the more accurate the frequency estimator). Each accumulation bank comprises 16×32 symbol duration accumulation registers 310, element 315 for taking the absolute value (ABS) and an accumulator 320 for providing a sum. Each 16×32 symbol duration accumulation registers 310 has 32 shift registers 16 symbols wide. Input mux 305 switches the input symbols at the sample position rate to different ones of the banks. The absolute value of all 16 registers (of x32) are taken, via ABS 315, and provided to accumulator 320, which provides the sum as an input signal to mux 325. Mux 325, driven by the sample rate position, provides output signal 256, which represents different values of the sums at different times (sample positions). The output signal 256 represents the signal “a” provided to element 265 (described above).

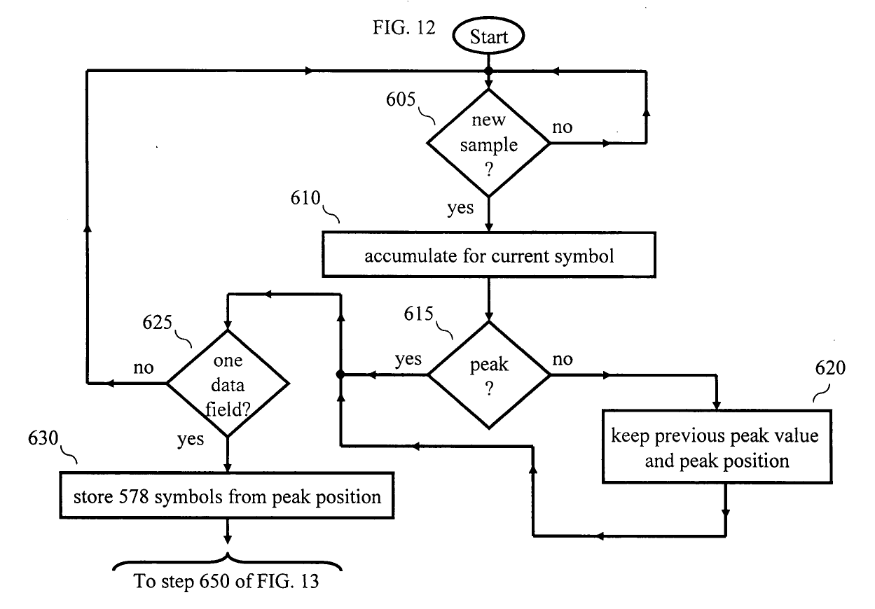

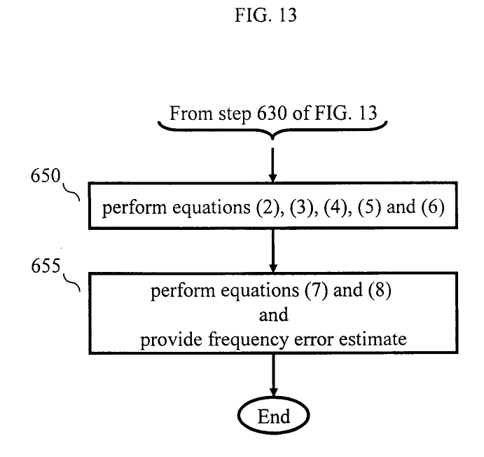

Turning now to FIG. 12, an illustrative flow chart is shown for use in element 225 of FIG. 9. In step 605, element 225 waits for a new sample to be ready. Once a new sample is ready, accumulation occurs for the current symbol in step 610. A check is made in step 615 if this is a peak value (e.g., the largest so far). If not, then the previous peak value and peak position is kept in step 620 and execution proceeds to step 625. On the other hand, if this is a new peak value, the new peak value and new peak position is stored in step 615 and execution also proceeds to step 625, which checks if an entire data field has bee processed. If an entire data field has not yet been processed, execution returns to step 605 to continue processing. However, if an entire data field has been processed, then 578 symbols from the peak position are stored in step 630 and execution proceeds to step 650 of FIG. 13, which represents the processing performed by frequency error estimator 230 for estimating a frequency error.

Referring now FIG. 13, in step 650, frequency error estimator 230 performs equations (2), (3), (4), (5) and (6) (all described below). Then, in step 655, frequency error estimator 230 performs equations (7) and (8) (both described below) for providing a frequency error estimate (signal 126) for use by NCO 140 of FIG. 5.

In the illustrative flow chart of FIG. 13, frequency error estimator 230 generates for use therein a complex valued field sync sequence C (this is a reference signal). A Hilbert filtering operation is illustratively used to generate the quadrature component of C_{q} from the field sync sequence shown in FIG. 3. As such,

C=Cᵢ+jC_{q}.

where C, is the in-phase component and C_{q} is the quadrature component. Similarly, the stored 578 symbols from the peak position (step 630 of FIG. 12) are provided as a complex signal D, to step 650 of FIG. 13, i.e.,

D=Dᵢ+jD_{q},

where Dᵢ is the in-phase component and D_{q} is the quadrature component.

In step 650 of FIG. 13, a number of equations are calculated. The first is equation (2), below, to determine a complex parameter S_{c}.

S_{c}=(Dᵢ+jD_{q})*(Cᵢ−jC_{q}). (2)

Then, equation (3), below, is calculated to determine a complex parameter Sₐ.

Sₐ=(Dᵢ+j*D_{q})*(Dᵢ−j*D_{q})+(Cᵢ+j*C_{q})*(Cᵢ−j*C_{q}). (3)

Then, equation (4), below, is calculated to normalize the parameters.

$$S = \frac{{S}_{c}}{{S}_{a}} = {S}_{i} + j * {S}_{q} , \qquad ( 4 )$$

where Sᵢ and S_{q} are the in-phase and quadrature components of S. Then an angle, A, for each symbol is determined in equation (5), below.

$$A = arctan ( \frac{Filtered ( Sq )}{Filtered ( Si )} ) , \qquad ( 5 )$$

where, Sᵢ and S_{q} are first passed through a simple low-pass filter to filter out any noise. However, in this particular application, the absolute value of the angle A is meaningless. What is important is the difference values, i.e., (Aₙ−Aₙ₋₁), which can be used to provide a frequency error estimate, i.e.,

∇A=Aₙ−Aₙ₋₁. (6)

It should be noted that the function arctan is valid in the range of [−ππ). As such, any non-continuous points should be removed before further processing. Normally there will be a small value for ∇A. If there is a non-continuous point, it will be a big value stand out. This information can be used to remove any non-continuous points from the result.

In step 655 of FIG. 13, equations (7) and (8) are calculated. Equation (7), below, determines an average angle value.

$$∇ {A}_{average} = \frac{1}{( 578 - N / 2 - 1 )} {\sum }_{n = 2}^{578 - \frac{N}{2}} ( {A}_{n} - {A}_{n - 1} ) . \qquad ( 7 )$$

Finally, equation (8), below, determines the frequency error estimate:

$$∇ F = \frac{∇ {A}_{average}}{SP} , \qquad ( 8 )$$

where SP is the symbol period. This frequency error estimate is provided via signal 126, as described above.

In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied in one, or more, integrated circuits (ICs). Similarly, although shown as separate elements, any or all of the elements (e.g., of FIG. 5) may be implemented in a stored-program-controlled processor, e.g., a digital signal processor, which executes associated software, e.g., corresponding to one, or more, of the steps shown in, e.g., FIGS. 7 and 8. Further, the principles of the invention are applicable to other types of communications systems, e.g., satellite, Wireless-Fidelity (Wi-Fi), cellular, etc. Indeed, the inventive concept is also applicable to stationary or mobile receivers. It is therefore to be understood that numerous modifications may be made to the illustrative embodiments and that other arrangements may be devised without departing from the spirit and scope of the present invention as defined by the appended claims.

1. A method for use in a receiver, the method comprising:
receiving a signal, the signal having a carrier; and
determining an initial frequency offset with respect to the carrier frequency in the received signal as a function of a synchronization signal in the received signal.

2. The method of claim 1, wherein the received signal is an Advanced Television Systems Committee.

3. The method of claim 2, wherein the synchronization signal is a field sync signal having a data segment sync followed by a pseudo-random sequence of 511 bits followed by three identical pseudo-random sequences of 63 bits concatenated together.

4. The method of claim 3, wherein the determining step determines the initial frequency offset as a function of no more than the data segment sync followed by the pseudo-random sequence of 511 bits followed by the first pseudo-random sequence of 63 bits.

5. The method of claim 1, further comprising the step of
selecting a first mode of operation, the first mode of operation being associated with determining the initial frequency offset;
wherein the determining step occurs after selection of the first mode.

6. The method of claim 5, further comprising the step of:
selecting a second mode of operation, the second mode of operation being associated with tracking the carrier frequency in the received signal using a carrier tracking loop;
wherein the determining step occurs before selection of the second mode.

7. The method claim 6, further comprising the step of:
determining if the carrier tracking loop is locked in the second mode of operation; and
if the carrier tracking loop is not locked, selecting the first mode of operation for determining the initial frequency offset.

8. The method claim 6, further comprising the step of:
determining if the carrier tracking loop is locked in the second mode of operation;
if the carrier tracking loop is not locked, selecting the first mode of operation; and
using a stored initial frequency offset in place of the determining step.

9. Apparatus for use in a receiver, the apparatus comprising:
a demodulator responsive to an estimated carrier signal for demodulating a received signal; and
a carrier recovery system;
wherein the estimated carrier signal is either derived from a signal representing an initial frequency offset determined from a synchronization signal in the received signal or a signal provided by the carrier recovery system.

10. The apparatus of claim 9, further comprising:
a multiplexer for selecting between the signal representing the initial frequency offset and the signal provided by the carrier recovery system.

11. The apparatus of claim 10, wherein the multiplexer selects the signal representing the initial frequency offset in a first mode of operation and selects the signal provided by the carrier recovery system in a second mode of operation.

12. The apparatus of claim 11, comprising:
a processor for determining if the carrier recovery system is locked in the second mode of operation, and if the carrier recovery system is not locked, selecting the first mode of operation for using the initial frequency offset.

13. The apparatus of claim 9, wherein the received signal is an Advanced Television Systems Committee.

14. The apparatus of claim 13, wherein the synchronization signal is a field sync signal having a data segment sync followed by a pseudo-random sequence of 511 bits followed by three identical pseudo-random sequences of 63 bits concatenated together.

15. The apparatus of claim 14, wherein the initial frequency offset is determined as a function of no more than the data segment sync followed by the pseudo-random sequence of 511 bits followed by the first pseudo-random sequence of 63 bits.
